(19) United States
(12) Patent Application Publication
(10) Pub. No.: US 2026/0175560 A1
(43) Pub. Date: Jun. 25, 2026

(54) Controlling movement of a flexible intermediate transfer member

(71) Applicant: LANDA CORPORATION LTD., Rehovot (IL)

(72) Inventors: Yuval Dim, Haniel (IL); Yossi Dror, Kiryat Ono (IL)

(21) Appl. No.: 19/129,694

(22) PCT Filed: Dec. 5, 2023
(86) PCT No.: PCT/IB2023/062235

§ 371 Date: May 14, 2025

Related U.S. Application Data
(60) Provisional application No. 63/430,362, filed on Dec. 6, 2022.

(51) Int. Cl. B41J 2/005; G03G 15/00; G03G 15/16

(52) U.S. Cl. CPC B41J 2/0057; G03G 15/1615; G03G 15/657

(57) ABSTRACT

A system (11) includes (a) an actuator (23, 25, 27), which is configured to tilt a roller (99, 77, 76) while an intermediate transfer member (ITM) (44) of a printing system (11) is moved thereon; and a controller (54, 20), which is configured to: (i) identify a distortion of the ITM (44), and 5 (ii) control the actuator (23, 25, 27) to tilt the roller (99, 77, 76) to reduce the distortion while the ITM (44) is being moved.

### FIELD OF THE INVENTION

The present invention relates generally to digital printing, and particularly to methods and systems for controlling movement of a flexible intermediate transfer member during a printing process.

### BACKGROUND OF THE INVENTION

Some printing systems comprise one or more intermediate transfer members that are typically moved for receiving an image and transferring the image to a target substrate. Various techniques for moving such intermediate transfer members have been published.

### SUMMARY OF THE INVENTION

An embodiment of the present invention that is described herein provides a system including an actuator, and a controller. The actuator is configured to tilt a roller while an intermediate transfer member (ITM) of a printing system is moved thereon, the controller is configured to: (i) identify a distortion of the ITM, and (ii) control the actuator to tilt the roller to reduce the distortion while the ITM is being moved.

In some embodiments, the ITM is moved along a continuous path in a first direction, and the controller is configured to reduce the distortion by: (i) identifying a first movement speed of the ITM in a second direction, different from the first direction, and (ii) controlling the actuator to tilt the roller for moving the ITM in a second movement speed, smaller than the first movement speed, while the ITM is being moved in the first direction.

In other embodiments, the controller is configured to receive a signal indicative of the first movement speed, and to control the actuator responsively to receiving the signal. In yet other embodiments, the system includes: (i) a first edge sensor, which is positioned at a first section of the continuous path and is configured to produce a first signal indicative of the first movement speeds at the first section, and (ii) a second edge sensor, which is positioned at a second section of the continuous path, different from the first section, and is configured to produce a second signal indicative of the first movement speed at the second section.

In some embodiments, in response to receiving the first and second signals, the controller is configured to identify a first distortion in the first section and a second distortion in the second section.

In other embodiments, the system includes a first actuator configured to tilt a first roller and a second actuator configured to tilt a second roller, and in response to identifying the first and second distortions, the controller is configured to control at least one of the first and second actuators to tilt the first and second rollers, respectively.

In yet other embodiments, the controller is configured to control: (i) the first actuator to tilt the first roller in a first tilting angle, and (ii) the second actuator to tilt the second roller in a second tilting angle, different from the first tilting angle.

In some embodiments, the controller is configured to control the first and second actuators to apply the first and second tilts concurrently. In other embodiments, the ITM is configured for receiving ink droplets to form an ink image thereon, and for transferring the ink image to a target substrate. In yet other embodiments, the controller is configured to: (i) hold a lookup table (LUT) including one or more known distortions caused by one or more operations carried out in the printing system, respectively, and (ii) control the actuator to tilt the roller in accordance with the LUT for reducing the one or more known distortions.

In some embodiments, the one or more known distortions includes a first known distortion in a first section on the ITM and a second known distortion in a second section of the ITM, and including a first actuator configured to tilt a first roller of the printing system and a second actuator configured to tilt a second roller of the printing system, and in response to identifying the first and second known distortion, the controller is configured to control at least one of the first and second actuators to tilt the first and second rollers, respectively.

In other embodiments, the controller is configured to control: (i) the first actuator to tilt the first roller in a first tilting angle, and (ii) the second actuator to tilt the second roller in a second tilting angle, different from the first tilting angle. In yet other embodiments, the controller is configured to control the first and second actuators to apply the first and second tilts concurrently.

In some embodiments, the controller is configured to: (i) hold a neural network (NN) configured to identify one or more known distortions caused by one or more operations carried out in the printing system, respectively, and (ii) in response to a given operation in the printing system, control the actuator to tilt the roller in accordance with an output of the NN for reducing the one or more known distortions.

In other embodiments, the controller is configured to receive one or more signals indicative of one or more additional distortions, respectively, and the controller is configured to apply the NN for identifying whether at least one of the one or more known distortions includes at least one of the one or more additional distortions. In yet other embodiments, the controller is configured to apply the NN for controlling the actuator responsively to receiving the signal.

In some embodiments, the printing system includes at least first and second rollers, and the controller is configured to control the actuator to tilt the first roller so that at least the first and second rollers are not parallel with one another. In other embodiments, the distortion of the ITM causes a deflection of the roller, wherein the roller is moved by a driver and includes an encoder, which is configured to produce a deflection signal indicative of a deflection angle of the roller, and the controller is configured to identify the distortion of the ITM based on the deflection signal.

In yet other embodiments, the system includes: (i) a chassis and at least first and second print bars, which are coupled to the chassis and are configured to apply to the ITM first and second colors of ink droplets to produce on the ITM first and second patterns of an image, respectively, and (ii) at least a given edge sensor, which is coupled with the chassis and is configured to produce (a) a first edge signal indicative of a first position of the chassis, and (b) a second edge signal indicative of a second position of an edge of the ITM being moved relative to the at least first and second print bars.

In some embodiments, a distortion in the chassis causes a color-to-color (C2C) registration error between the first and second patterns of the image, and based on the first and second edge signals, the controller is configured to: (i) identify the distortion of the chassis, (ii) estimate the C2C registration error, and (iii) control the actuator to tilt the roller to reduce the C2C registration error by compensating for the distortion of the chassis while (a) the ITM is being moved, and (b) the first and second print bars apply the first and second colors of ink droplets.

In some embodiments, the controller is configured to control at least the first and second print bars, to adjust at least one of first and second timings of applying the first and second colors of ink droplets, respectively, to reduce the C2C registration error in the image.

In other embodiments, the ITM has multiple marks, which are formed at a predefined distance from one another along at least an edge of the ITM, and including one or more sensors, which are configured to produce multiple signals indicative of multiple positions of the multiple marks, respectively, and, the controller is configured to control at least one of: (i) the first movement speed, and (ii) the actuator, based on the multiple signals.

In yet other embodiments, at least one of the marks includes multiple trapezoids, and the controller is configured to estimate at least one of: (i) a movement speed in the first direction, and (ii) the first movement speed, based on the multiple signals indicative of the multiple positions of the multiple trapezoids, respectively.

In some embodiments, the multiple trapezoids include multiple right-angled trapezoids having (i) multiple orthogonal edges, respectively, which are orthogonal to the first direction, and (ii) multiple diagonal edges, respectively, which are extended at a predefined angle relative to the first direction, and, the controller is configured to estimate at least the movement speed in the first direction based on the multiple signals indicative of respective multiple positions of the orthogonal edges, respectively.

In other embodiments, the multiple marks include: (i) a first mark having a first orthogonal edge and a first diagonal edge, and (ii) a second mark having a second orthogonal edge and a second diagonal edge, and the controller is configured to receive given signals indicative of the orthogonal edges and the diagonal edges, and based on the signals, to identify the distortion of the ITM by estimating: (a) a first distance between the first orthogonal edge and the first diagonal edge, and (b) a second distance between the second orthogonal edge and the second diagonal edge.

In yet other embodiments, in response to the movement of the ITM in the second direction, the controller is configured to: (i) identify a difference between the first distance and the second distance, and (ii) estimate a size of the movement of the ITM in the second direction based on: (a) the estimated difference between the first distance and the second distance, and (b) the predefined angle.

In some embodiments, the multiple trapezoids include multiple isosceles trapezoids having (i) multiple third diagonal edges, respectively, which are extended at a first angle relative to the first direction, and (ii) multiple fourth diagonal edges, respectively, which are extended at a second angle relative to the first direction, the controller is configured to receive third signals and fourth signals indicative of third positions and fourth positions of the third and fourth diagonal edges, respectively, the multiple isosceles trapezoids include first and second isosceles trapezoids located at a given distance, and, based on the third and fourth signals, the controller is configured to identify the distortion of the ITM by estimating: (a) a third distance between the third and fourth diagonal edges of the first isosceles trapezoid, and (b) a fourth distance between the third and fourth diagonal edges of the second isosceles trapezoid.

In other embodiments, the controller is configured to estimate a size of the movement of the ITM in the second direction based on: (a) the estimated difference between the third distance and the fourth distance, and (b) the first and second angles.

In some embodiments, at least one of the marks includes one or more polygons having pairs of edges that are orthogonal to the first direction, and the controller is configured to estimate at least a movement speed in the first direction based on given signals, which are indicative of given positions of one or more of the pairs of the edges, respectively.

In other embodiments, the ITM has a first axis, and a second axis orthogonal to the first axis, the marks include third marks formed along one or more first edges of the first axis, and fourth marks formed along one or more second edges of the second axis, and the controller is configured to: (i) identify at least one of: (a) a third distortion of the ITM based on the third marks, (b) a fourth distortion of the ITM based on the fourth marks, and (c) a fifth distortion of the ITM based on the third and fourth marks, and (ii) control the actuator to tilt the roller to reduce at least one of the third, fourth and fifth distortions while the ITM is being moved.

In some embodiments, based on at least one of the multiple signals, the controller is configured to control an operation of at least one station or assembly of the system. In other embodiments, the at least one station or assembly is selected from a list consisting of (a) an image forming station configured to apply ink droplets to the ITM and produce an image on the ITM, (b) an impression station configured to transfer the image to a target substrate, (c) at least the roller configured to move the ITM, (d) one or more drying assemblies configured to at least partially dry the ink droplets on the ITM, and (e) an ITM treatment station.

In some embodiments, the impression station includes a rotatable impression cylinder and a rotatable pressure cylinder, configured to transfer the image to the target substrate, and based on at least one of the multiple signals, the controller is configured, to control at least one operation selected from a list consisting of (a) timing of engagement and disengagement between the impression and pressure cylinders, (b) a motion profile of at least one of the impression and pressure cylinders, and (c) a size of a gap between the disengaged impression and pressure cylinders.

There is additionally provided, in accordance with an embodiment of the present invention, a method including identifying a distortion of an intermediate transfer member (ITM) that is moved on a roller of a printing system. An actuator is controlled to tilt the roller to reduce the distortion while the ITM is being moved.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIG. 2A is a schematic top view showing undesirable movement of a blanket of the digital printing system during a printing process, and sensors configured to detect the position of edges of the blanket, in accordance with an embodiment of the present invention;

FIG. 2B is a schematic top view showing a compensation of the undesirable movement of the blanket during the printing process, in accordance with an embodiment of the present invention;

FIG. 3 is a schematic pictorial illustration showing controlling the movement of the blanket in a Y-axis, in accordance with an embodiment of the present invention;

FIG. 4 is a schematic side view of the blanket and graphs for illustrating a method for distinguishing between a blanket cutting error and undesired movement of the blanket, in accordance with an embodiment of the present invention;

FIG. 5 is a flow chart that schematically illustrates a method for reducing distortion in the blanket that undesirably moves along Y-axis during the printing process, in accordance with an embodiment of the present invention;

FIG. 6A is a schematic top view showing alignment between the movement of the blanket and the printing of patterns by print bars of the system of FIG. 1, in accordance with an embodiment of the present invention;

FIG. 6B is a schematic top view showing detection of undesirable distortion in the blanket of the digital printing system during a printing process, in accordance with an embodiment of the present invention; and

FIG. 7 is a schematic top view showing detection of a distortion in a sidewall of the chassis of the digital printing system resulting in color-to-color (C2C) registration error during a printing process, in accordance with an embodiment of the present invention.

### DETAILED DESCRIPTION OF EMBODIMENTS OVERVIEW

Some printing systems have a movable intermediate member, which is configured to receive an image and to transfer the image to a target substrate. In some cases, the intermediate member is flexible and may be distorted when being moved, which may result in distortions in the printed image and reduced printing output of the printing system.

In principle, it is possible to couple the edges of the flexible intermediate member to a conveyance subsystem, which is configured to control the movement of the intermediate member. One example implementation of a conveyance subsystem is a zipper, which is configured to couple between the conveyance subsystem and the intermediate member. Such coupling mechanisms (e.g., zipper), however, may introduce non-uniform flexibility in the flexible member, and therefore, may cause distortions in the printed image, as well as various malfunctions in the operation of the printing system.

Embodiments of the present invention that are described hereinafter provide improved techniques for controlling the movement of a flexible intermediate member (ITM), so as to reduce or prevent distortions when the ITM is being moved for printing images.

In some embodiments, a digital printing system, also referred to herein as a system, for brevity, comprises an image forming system configured to apply droplets of one or more printing fluids to an ITM, also referred to herein as a blanket, for producing an image thereon. The system comprises an impression station configured to transfer the image from the blanket to a target substrate, such as a sheet or a continuous web, e.g., by conducting an alternating engagement and disengagement between the blanket and the target substrate.

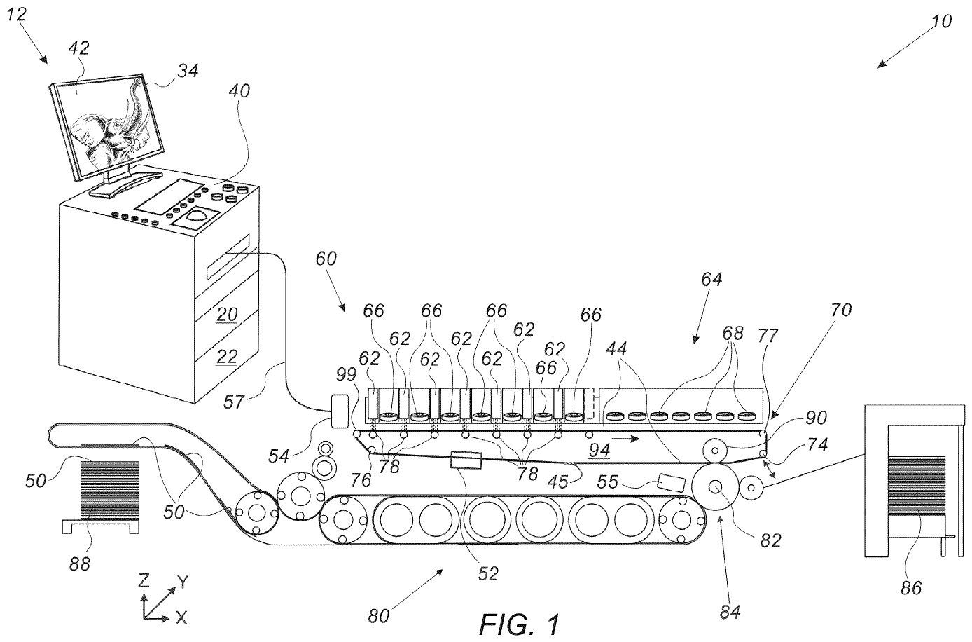

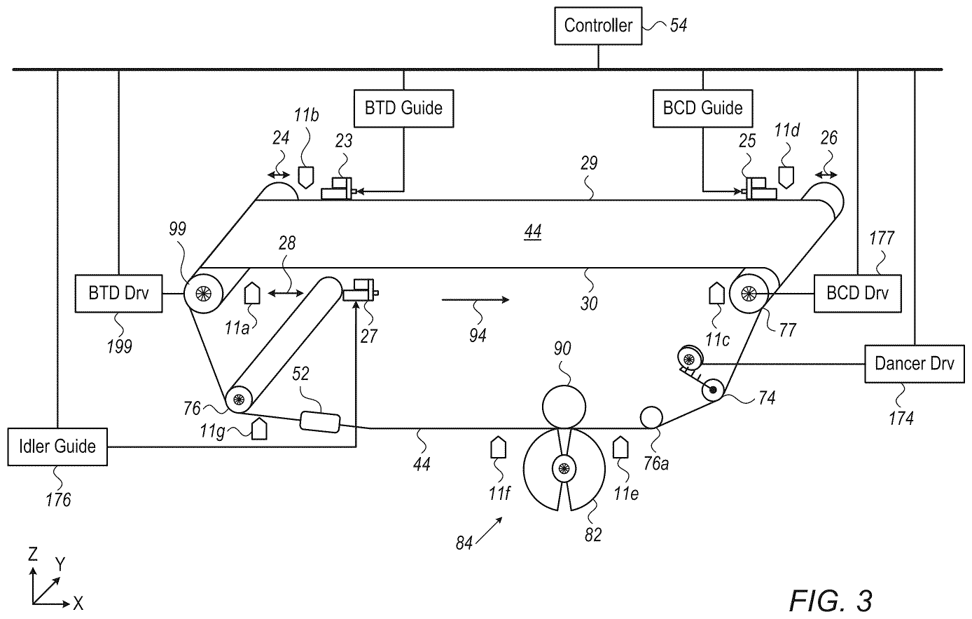

In some embodiments, the blanket is formed in an endless loop (e.g., using a seam between ends of the blanket), and the system comprises multiple rollers for moving and guiding the blanket along an endless continuous path shown for example in FIGS. 1 and 3 below. Some of the rollers are motorized and controlled by a controller of the system for moving and guiding the blanket, and the other rollers are not motorized and are used mainly for guiding the moved blanket.

In some embodiments, the system comprises one or more actuators, which are configured to tilt one or more respective rollers of the system while the blanket is being moved thereon.

In some embodiments, the controller of the system is configured to identify and reduce a distortion in the blanket. The distortion identification and reduction may be carried out in a proactive mode (i.e., before occurring) or in a reactive mode (i.e., after occurring), or in a combination of both modes, as will be described herein.

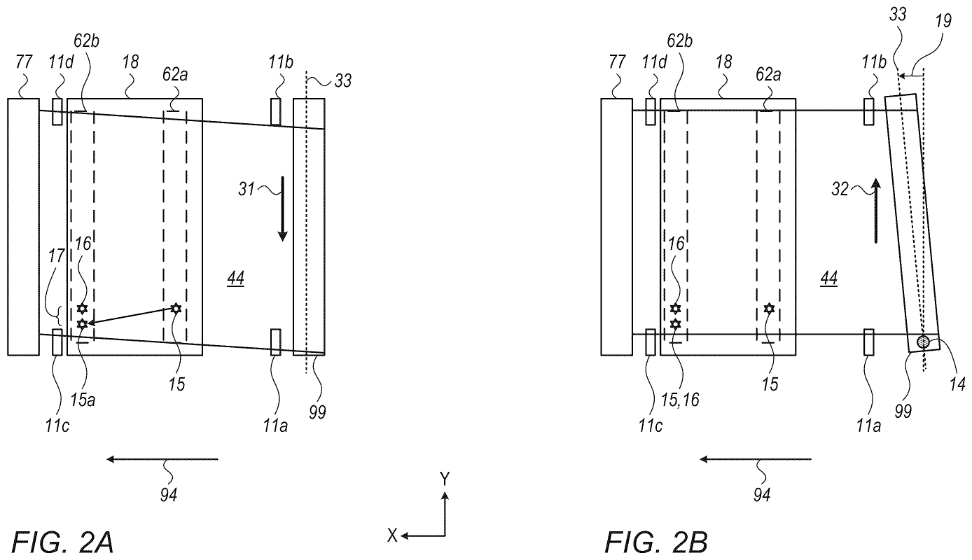

In some embodiments, the system comprises one or more sensors, which are positioned at one or more respective sections of the system. When the blanket is moved in a first direction, e.g., along an X-axis of the system for performing the printing, the one or more sensors are configured to produce one or more respective signals indicative of the position of one or both edges of the blanket in a second direction, different from the first direction. In the present example, the second direction is parallel to a Y-axis of the system, which is orthogonal to the X-axis. Embodiments related to the sensors and the respective signals are described in more detail, for example, in FIGS. 2A, 3 and 4 below.

In some embodiments, in the reactive mode the controller is configured to receive the signals from the sensors, and based on the signals, the controller is configured to calculate or estimate the movement speed of the blanket along the y-axis in the respective sections of the system. For example, in a first section in which the droplets are applied to the blanket using print bars arranged along the X-axis, the blanket movement in Y-axis may cause a color-to-color (C2C) registration error, which is described in detail in FIGS. 1 and 2A below. Similarly, in a second section that is positioned in the system before transferring the image to the target substrate, the blanket movement in Y-axis may result in a registration error of the position of the image on the target substrate, also referred to herein as image-to-substrate (I2S) registration error, which is described in detail in FIGS. 1 and 2A below.

In some embodiments, the controller is configured to hold one or more thresholds indicative of the allowed movement speed of the blanket in Y-axis. Note that because the specification of the C2C registration error is tighter than the specification of the I2S registration error, the respective thresholds of the allowed maximal speed may differ from one another.

In some embodiments, in the reactive mode, when identifying that the estimated movement speed of the blanket in a given section is larger than the respective threshold, the controller is configured to control one or more of the actuators to tilt the one or more respective rollers in a selected angle for reducing the movement speed of the blanket in Y-axis while the blanket is being moved. Note that the roller(s) tilting reduces the blanket distortion in the given section of the system and improves the quality of the printed image. Embodiments related to the reactive mode are described in more detail, for example, in FIGS. 2A, 3 and 4 below.

In some embodiments, the controller is configured to hold a lookup table (LUT) comprising one or more known distortions caused by one or more operations carried out in the system, respectively. For example, a replacement of a blade in a blanket treatment (e.g., cleaning) station that is described in detail in FIG. 3 below, may alter the force(s) applied to the moving blanket and may cause a known movement of the blanket along the Y-axis (and therefore a distortion of the blanket). Embodiments related to the LUT are described in more detail, for example, in FIG. 3 below.

In some embodiments, in the proactive mode the controller is configured to control one or more of the actuators to tilt the respective rollers before starting a printing job, so as to proactively prevent a distortion of the blanket that may be cause by uncontrolled movement of the blanket along the Y-axis, as described above.

In other embodiments, instead of or in addition to the LUT, the controller is configured to hold a neural network (NN), which is trained to identify one or more distortions in the blanket caused by uncontrolled movement of the blanket along the Y-axis. Embodiments related to the NN are described in more detail, for example, in FIG. 3 below.

The disclosed techniques improve the quality of images printed in the system and improve the productivity of such printing systems. Embodiments related to additional improvements, such as but not limited to reducing the appearance of a memory effect are described in the detailed description below.

### SYSTEM DESCRIPTION

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44.

In the context of the present invention, the term “run” refers to a length or segment of blanket 44 between any two given rollers over which blanket 44 is guided.

In some embodiments, during installation, blanket 44 may be adhered edge to edge, using a seam section also referred to herein as a seam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as approximately the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” “color to color position difference,” “bar to bar registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 may comprise a fabric (not shown) and any suitable types of additional layers. Detailed embodiments related to structures of the stacked layers of any suitable blanket, such as blanket 44, are provided for example, in PCT International Publications WO 2017/208144, and in PCT Patent Application PCT/IB2019/055288, whose disclosures are all incorporated herein by reference.

In some embodiments, the fabric comprises two or more sets of fibers (not shown) interleaved with one another. In the present example, the two sets of fibers are substantially orthogonal to one another and the fibers of one set of the fibers are laid out parallel to one another and to moving direction 94. Moreover, the fabric of blanket 44 has an opacity that varies in accordance with a periodic pattern of the fibers.

In some embodiments, the fabric of blanket 44 may comprise any suitable number of fibers, e.g., between 20,000 and 30,000 fibers. In the set of fibers arranged parallel to moving direction 94, each fiber and/or a distance between adjacent fibers may be used as a position reference along the movement axis of blanket 44.

In some embodiments, a processor 20 (described below) of system 10 may use the position of one or more fibers of blanket 44, for controlling the position and movement parameters of blanket 44. Detailed embodiments related to controlling the movement of blanket 44, are provided for example, in PCT International Publication WO 2021/044303, whose disclosures is incorporated herein by reference.

In some embodiments, blanket 44 is guided over rollers 78, an idler 76, and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, idler 76 and dancer assembly 74 may both be motorized, and idler 76 is described in more detail in FIG. 3 below. Moreover, the configuration and operation of rollers 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively. For example, BTD 99 is coupled to a rotor of the electric motor and the stator of the electric motor is coupled to (the chassis of) system 10. The same arrangement is applied to BCD 77.

In some embodiments, each of idler 76, BCD 77 and BTD 99 is configured to rotate about a respective axis, also referred to herein as a rotation axis. The rotation axis of each of idler 76, BCD 77 and BTD 99 may comprise a rotatable roller shown in FIG. 2 below. In some embodiments, at least one of and typically each rotatable roller of idler 76, BCD 77 and BTD 99 has a first end that is fixed and is configured to serve as a pivot, and a second end configured to be moved about the pivot at one or more controlled angles, as will be described in detail in FIG. 2 below.

In some embodiments, system 10 comprises one or more edge sensors (shown in FIGS. 2A, 2B, 3 and 4 below) disposed at one or more positions along blanket 44. Each edge sensor is configured to produce a signal indicative of the position of an edge (shown in FIGS. 2A, 2B, 3 and 4 below) of blanket 44 along Y-axis, which is orthogonal to moving direction 94 of blanket 44.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74 and of other components, such as but not limited to idler 76, BCD 77 and BTD 99.

In some embodiments, in impression station 84, blanket 44 passes between an impression cylinder 82 and a pressure cylinder 90, which is configured to carry a compressible blanket. In some embodiments, a motion encoder is integrated with at least one of impression cylinder 82 and pressure cylinder 90

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters into image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single-sided and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

As briefly described above, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44. Subsequently, sheet 50 is transported to output stack 88.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, station 55 may comprise a spectrophotometer (not shown) configured to monitor the quality of the ink printed on sheet 50.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 may print testing marks (not shown) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of thresholds, and (iii) output sheets 50 having minor distortions, e.g., below the second set of thresholds, to output stack 88.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

### Detecting Undesirable Movement of Blanket During a Printing Process

FIG. 2A is a schematic top view showing undesirable movement of blanket 44 during a printing process, and sensors 11 configured to detect the position of edges of blanket 44, in accordance with an embodiment of the present invention.

In some cases, when blanket 44 is moved in moving direction 94 (as described in FIG. 1 above), various operations related to the printing process may cause undesirable movement of blanket 44, for example, in Y-axis that is orthogonal to moving direction 94.

In principle, it is possible to move a blanket in system 10 using a zipper, which is integrated with the blanket and is configured to reduce movements of the blanket along Y-axis. Such blanket is described, for example, in U.S. Patent Application Publications 2022/0357699, 2022/0250376, 2018/0126726, and 2021/0260869, whose disclosures are all incorporated herein by reference. The zipper, however, may increase the friction between the blanket and a transportation system, and may cause various failures and/or registration errors during a printing process carried out in system 10.

In some embodiments, blanket 44 is zipper-less, i.e., has not integrated zipper. In the present example, blanket 44 is moved using motorized rollers, such as but not limited to BTD 99 and BCD 77 described in FIG. 1 above.

In the example of FIG. 2A, blanket 44 slips in a direction 31 along BTD 99 having an axis 33, also referred to herein as a longitudinal axis or a rotation axis of BTD 99. Note that, as shown in FIG. 2A, blanket 44 is distorted because of the movement in direction 31. When blanket 44 is moved in moving direction 94 and passes below image forming station 60, print bars 62a and 62b are configured to apply first and second colors, respectively, to a printing zone 18 of blanket 44. In the present example, print bars 62a and 62b are configured to apply droplets of blue and magenta ink, respectively, to the same position on the surface of blanket 44.

In the design of the image intended to be printed, a blue pattern is intended to be printed on blanket 44 at a position 15. In some cases, the undesirable movement of blanket 44 in direction 31 may result in printing of the blue pattern at a position 15a, which is at an offset in Y-axis relative to intended position 15. When printing zone 18 of blanket 44 passes below print bar 62b, a magenta pattern is printed at a position 16, which is intended to overlay intended position 15 of the blue pattern. Therefore, the undesirable movement of blanket 44 in direction 31 results in a C2C registration error 17 between the blue and magenta patterns.

In some embodiments, system 10 comprises one or more edge sensing devices, referred to herein as sensors 11, which are configured to detect the position of the respective edges of blanket 44. In the present example, system 10 comprises sensors 11a and 11c positioned at a first side of blanket 44, and sensors 11b and 11d positioned at a second side of blanket 44, opposite the first side.

In some embodiments, sensors 11a-11d may comprise any suitable type of edge sensors. For example, a laser-based PosCon OXE7 sensor produced by Baumer Electric AG (Hummelstrasse 17, 8500 Frauenfeld, Switzerland), or a suitable ultrasound-based sensor, or any other suitable type of sensor based on any suitable technique.

In some embodiments, each of sensors 11a-11d is configured to send to controller 54 (and/or to processor 20) one or more signals indicative of the position of the respective edge of blanket 44. In some embodiments, based on the signals received from sensors 11a-11d, controller 54 is configured to identify a distortion caused in blanket 44.

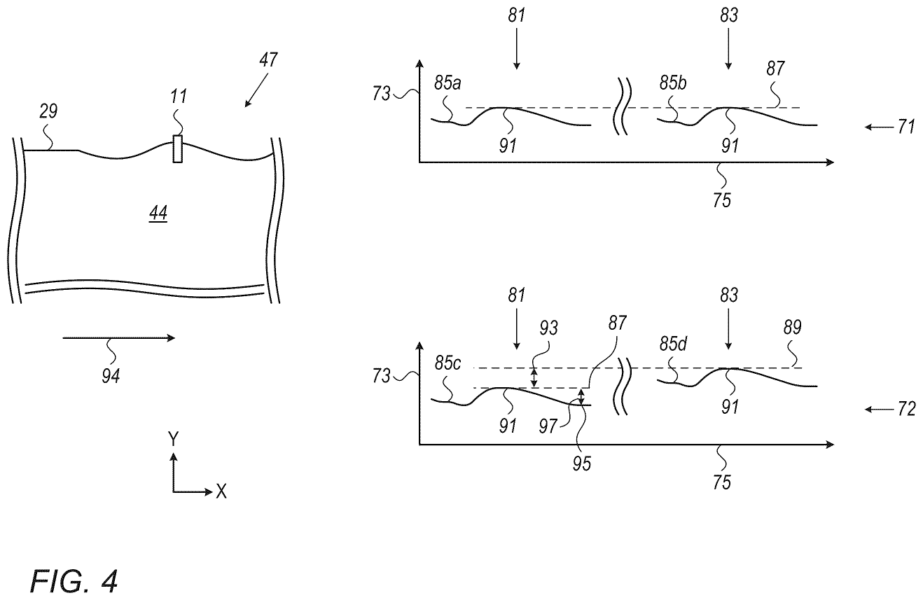

In other embodiments, system 10 may comprise one or more of sensors 11a-11d arranged in any suitable combination. In a first example implementation, system 10 comprises only sensor 11a for detecting the position of the respective edge of blanket 44. In a second example implementation, system 10 comprises sensors 11a and 11b, and controller 54 is configured to calculate the actual size of blanket 44 in close proximity to BTD 99. Note that the calculated size of blanket 44 is indicative of the stretching level of blanket 44 (e.g., whether or not blanket 44 is sufficiently taut) and/or a distortion of blanket 44 that may be caused at least by the undesired movement of blanket 44 in direction 31. In a third example implementation, system comprises sensors 11a and 11c, and controller 54 is configured to calculate, inter alia, (i) the actual size of a section blanket 44 between sensors 11a and 11c, (ii) non-uniform blanket cutting during the production process of blanket 44 (described among other methods for doing the same in FIG. 4 below), (iii) undesired movement of blanket 44 in direction 31, and other parameters related to components of system 10 and features related to blanket 44 and to the mounting of blanket 44 on system 10.

In alternative embodiments, the number of sensors 11 and the position of each sensor 11 is determined so as to detect any sort of non-uniformity related to blanket 44 and the movement thereof. For example, insufficient parallelism between rollers, a variation in the movement of blanket 44 in movement direction 94, the shape of blanket 44, and any other non-uniformity in system 10 that may affect the blanket movement and/or the quality of image forming and image transferring, as will be described in more detail in FIG. 3 below.

### Compensating for Undesirable Movement of Blanket by Tilting a Roller of the Printing System

FIG. 2B is a schematic top view showing a compensation of the undesirable movement of blanket 44 during the printing process carried out in system 10, in accordance with an embodiment of the present invention.

As described above, controller 54 is configured to identify a distortion caused in blanket 44. In some embodiments, in response to detecting, based on the signals received from one or more sensors 11a-11d, the distortion caused by the undesired movement of blanket 44 in direction 31 (as described in FIG. 2A above), controller 54 (and/or processor 20) is configured to control tilting of BTD 99 in order to reduce the distortion, e.g., by compensating for the undesired movement, and/or by reducing the speed of the undesired movement.

In some embodiments, a first end of BTD 99 is fixated (e.g., to the chassis of system 10) and serves as a pivot 14, and a second end of BTD is movable about pivot 14. In the example of FIG. 2B, controller 54 is configured to control an actuator (shown in FIG. 3 below), which is configured to move the second end of BTD 99 in a preassigned vector 19, so that axis 33 is rotated at a given angle relative to the position of axis 33 shown in FIG. 2A above.

In some embodiments, when blanket 44 is moved in moving direction 44, the tilting of BTD 99 causes movement of blanket 44 in a direction 32, so as to compensate for the movement in direction 31 shown in FIG. 2A above. Note that the tilting of BTD 99 is performed when the movement speed of blanket 44 in direction 31 is larger than a predefined threshold. For example, tilting BTD 99 is not required in case blanket 44 is moved about 10 μm in direction 31 when blanket 44 is moved about 2 meters in movement direction 94. However, tilting of BTD 99 is required in case blanket 44 is moved about 1 mm in direction 31 when blanket 44 is moved about 1 meter.

In some embodiments, controller 54 (and/or processor 20) is configured to control the amount of tilting (e.g., a tilting angle) and the tilting rate of BTD 99, so as to reduce the movement speed of blanket 44 in Y-axis (e.g., in direction 31 of FIG. 2A above. In the context of the present disclosure and in the claims, the term “reduce the movement speed” (or “reduce the movement rate”) in a given direction, refers to reducing the movement speed in the same direction, or reversing at least a component of a vector indicative of the direction of the movement speed. For example, in FIG. 2A blanket 44 is distorted by being moved in a given speed in direction 31. In this example, controller 54 is configured to either reduce the speed of the blanket movement in direction 31, or reverse the movement direction to direction 32 shown in FIG. 2B above. When moved in the reversed direction (i.e., in direction 32), the speed of blanket 44 in direction 31 is negative, and is therefore reduced relative to the movement speed of blanket 44 in direction 31 as shown in FIG. 2A above.

In some embodiments, when obtaining a desired movement speed of blanket 44 along the Y-axis (e.g., below a given threshold), controller 54 is configured to retain the tilting angle of BTD 99. In the present example, when obtaining a sufficiently low movement speed of blanket in Y-axis, the blue pattern and the magenta pattern are printed in positions 15 and 16, respectively, so that the C2C registration error (e.g., C2C registration error 17 of FIG. 2A above) is smaller than a predefined threshold. For example, in FIG. 2A C2C registration error 17 is about 0.1 mm, whereas in FIG. 2B the C2C registration error between the blue and magenta patterns is smaller than about 10 μm.

In some embodiments, in response to detecting, based on the signals received from one or more sensors 11a-11d, the distortion caused by the undesired movement of blanket 44 in direction 31, controller 54 (and/or processor 20) is configured to control both: (i) the tilting angle of BTD 99 and/or any other one or more rollers that participate in the rotation of blanket 44 (to compensate for the mechanical distortion in blanket 44), and (ii) the timing of the droplets of printing fluid applied to blanket 44 by one or more print bars 62 of image forming station (to compensate for C2C registration error caused by the mechanical distortion in blanket 44).

In some embodiments, in addition to (a) a mechanical-based correction by tilting one or more of the rollers (as described above), processor 20 and/or controller 54 are configured to compensate for the C2C registration error and scale distortions in the printed image (as will be described in detail below), by applying software-based corrections, such as but not limited to: (i) adjusting the speed of blanket 44 along moving direction 94, and (ii) adjusting the timing in which each of print bars 62 applies the droplets of ink color to blanket 44.

Moreover, in some cases, based on the signals received from one or more sensors 11a-11d and/or from other sensors of system 11 (e.g., station 55 described in FIG. 1 above), processor and/or controller 54 are configured to control impression station 84 to adjust the operation of impression cylinder 82 and pressure cylinder 90 (described in FIG. 1 above) in order to compensate for or eliminate various distortions occurred in the image printed on blanket 44. In one implementation, based on the aforementioned signals, processor 20 and/or controller 54 are configured to estimate an image-to-substrate registration error (described in FIG. 1 above), and to control at least one operation selected from a list of operations consisting of (a) the timing of engagement between impression cylinder 82 and pressure cylinder 90 of impression station 84 in order to compensate for the image-to-substrate registration error, (b) the motion profile of at least one of impression cylinder 82 and pressure cylinder 90, and (c) the size of a gap between the disengaged impression cylinder 82 and pressure cylinder 90.

In another implementation, based on the aforementioned signals, processor 20 and/or controller 54 are configured to estimate that one or more of the distortions and/or errors described above that have been occurred on blanket 44 exceed the specification of the printed image. As such, processor 20 and/or controller 54 are configured to stop the operation of one or more stations of system 11, such as but not limited to (a) image forming station 60, (b) impression station 84, (c) one or more of the rollers configured for guiding blanket 44, (d) one or more drying assemblies such as drying station 64, and (e) blanket treatment station 52. For example, processor 20 and/or controller 54 are configured to prevent the engagement between impression cylinder 82 and pressure cylinder 90 of impression station 84, and/or to stop the application of the ink droplets by one or more print bars 62 of image forming station 60.

Additionally, or alternatively, the corrective action may be carried out proactively, rather than in response to detecting the distortion. The proactive corrective action may be carried out based on pre-characterization of the system before starting a printing job, for example, by running testing jobs in the same conditions of the intended printing job. Moreover, some of the distortions are caused by heating of blanket 44 and other components of system 10. The heating may be caused by infrared radiation applied to blanket 44 by heaters 66 and/or drying station 64, as described above.

In other embodiments, controller 54 is configured to apply tilting to one or more selected rollers of system 10, for example, tilting both BTD 99 and BCD 77 concurrently, as will be described in detail in FIG. 3 below.

In the context of the present disclosure and in the claims, embodiments related to any computational and/or controlling operation may be carried out using controller 54 or processor 20, or using any suitable combination of controller 54 and processor 20.

Note that the configuration presented in FIG. 2B is simplified for the sake of conceptual clarity and is provided by way of example for demonstrating embodiments of the present invention.

FIG. 3 is a schematic pictorial illustration showing controlling the movement speed of blanket 44 along the Y-axis, in accordance with an embodiment of the present invention. FIG. 3 describes embodiments related to applying the techniques shown in FIG. 2B above to one or more selected components of system 10 for reducing errors in an image printed in system 10.

In some embodiments, system 10 comprises a BTD driver 199, which is controlled by controller 54 and is configured to drive BTD 99 (e.g., based on signals received from one or more position encoders described in FIG. 1 above). System 10 further comprises a suitable actuator, referred to herein as an actuator 23, which is controlled by controller 54 or a BTD guide (e.g., a slave of controller 54). In the present example, actuator 23 comprises a linear actuator made from a motorized screw configured to move the non-fixated end (also referred to as the second edge in FIG. 2B above) of BTD 99 in a controlled direction 24. Note that direction 24 is shown using a bidirectional arrow because actuator 23 is configured to be moved back and forth (e.g., along X-axis).

In the example of FIG. 3, each of BTD 99, BCD 77 and idler 76 has one fixated end, also referred to herein as a first end, and one non-fixated end, also referred to herein as a second end, which is configured to be moved by a suitable actuator, such as actuator 23, as will be described in detail herein.

In some embodiments, system 10 comprises a BCD driver 177, which is controlled by controller 54 and is configured to drive BCD 77 based on signals received from one or more position encoders described in FIG. 1 above. System 10 further comprises a motorized actuator 25, which has similar features of actuator 23 and is controlled using controller 54 or a BCD guide (a slave of controller 54).

In some embodiments, actuator 25 is configured to move the non-fixated end (i.e., the second edge) of BCD 77 in a controlled direction 26. Note that direction 26 is shown using a bidirectional arrow because actuator 25 is configured to be moved back and forth (e.g., along X-axis).

In some embodiments, idler 76 is not motorized and when blanket 44 is moved, idler is configured to be rotated by the blanket about its longitudinal axis. System 10 further comprises a motorized actuator 27, which has similar features of actuator 23 and is controlled by controller 54 or using an idler guide 176 (e.g., a slave of controller 54).

In some embodiments, actuator 27 is configured to move the non-fixated end (i.e., the second edge) of idler 76 in a controlled direction 28. Note that direction 28 is shown using a bidirectional arrow because actuator 27 is configured to be moved back and forth (e.g., along X-axis).

In the present example, the first end of idler 76, BCD 77 and BTD 99 are all fixated in close proximity to an edge 30 of blanket 44, and actuators 23, 25 and 27 are positioned in close proximity to the second ends of idler 76, BCD 77 and BTD 99, respectively, which are positioned in close proximity to an edge 29 of blanket 44. In other embodiments, the ends of at least one of idler 76, BCD 77 and BTD 99 may be switched, and the position of the respective actuator may be altered respectively. For example, the non-fixated end of idler 76, and actuator 27, may both be positioned in close proximity to edge 30 of blanket 44.

In some embodiments, system 10 comprises additional components, such as but not limited to a dancer driver 174 (configured to drive dancer 74) and an idler 76a, which may be related to the movement of blanket 44 but are not described in embodiments of the present invention.

In some embodiments, blanket 44 is moved along an endless continuous path shown in FIGS. 1 and 3, and system 10 comprises multiple edge sensors, such as sensors 11a-11d shown in FIGS. 2A and 2B above. System 10 comprises additional sensors (described below) that are distributed in different sections of system 10 along the continuous path of blanket 44. In the example of FIG. 3, sensors 11a and 11b are positioned in close proximity to BTD 99, sensors 11c and 11d are positioned in close proximity to BCD 77, sensor 11e is positioned between idler 76a and impression station 84, sensor 11f is positioned between impression station 84 and blanket treatment station 52, and sensor 11g is positioned between blanket treatment station 52 and idler 76. Sensors 11a and 11c are configured to detect the position of edge 30, sensors 11b and 11d are configured to detect the position of edge 29.

In an embodiment, each of sensors 11e, 11f and 11g may comprise one sensor positioned in close proximity to either edge 29 or 30 for detecting the position of the respective edge. In another embodiments, one or more of sensors 11e, 11f and 11g comprises two sensors positioned in close proximity to edges 29 and 30, respectively.

In principle, every interaction between blanket 44 and another element or component may affect the movement speed of blanket 44 in Y-axis. For example, undesired movement along Y-axis may be caused by: (i) unintended tilting of one or more rollers (e.g., BTD 99, BCD 77, idlers 76 and 76a, rollers 78), one or more rollers of blanket treatment station 52 (as will be described in more detail below), or one or both of pressure cylinder 90 and impression cylinder 82, or another element placed in contact with both edges 29 and 30, (ii) at least two rollers (typically in close proximity, e.g., BTD 99 and idler 76) that are not parallel with one another, (iii) a deviation in contact force between blanket 44 and an element placed in contact therewith. For example, a replacement of a revolver (i.e., a scrapping blade, not shown) in blanket treatment station 52, may alter the force applied to blanket 44, and may result in movement of blanket 44 along Y-axis, (iv) non uniform thermal expansion of an element placed in contact with blanket 44 along Y-axis. For example, a first end of a roller expands more than the second end, (v) any other reason that may affect the forces applied to blanket 44.

In some embodiments, based on the signals received from one or both of sensors 11a and 11b, controller 54 is configured to estimate C2C registration error that may be caused by the movement of blanket 44 is Y-axis, as described in FIG. 2A above. For example, blanket 44 may be moved along Y-axis in case: (i) BTD 99 is tilted unintentionally (e.g., when being mounted on system 10), (ii) BTD 99 and BCD 77 are not parallel with one another, (iii) BTD 99 and idler 76 are not parallel with one another, (iv) non uniform thermal expansion of the ends of BTD 99, or for any other reason.

In some embodiments, based on the signals received from one or more of sensors 11c, 11d and 11e, controller 54 is configured to estimate image-to-substrate (12S) registration error that may be caused by the movement of blanket 44 is Y-axis. For example, blanket may be moved in case: (i) at least one of BCD 77, dancer 74 and idler 76a is tilted unintentionally (e.g., when being mounted on system 10), (ii) two or more of BCD 77, dancer 74 and idler 76a are not parallel with one another, (iii) non uniform thermal expansion of the ends of at least one of BCD 77, dancer 74 and idler 76a, and (iv) improper mounting or operational malfunction of one or both of pressure cylinder 90 and impression cylinder 82, in particular when being engaged when the ink image is impressed onto the surface of sheet 50, as described in FIG. 1 above.

As described above, a blade replacement in the revolver (not shown) of blanket treatment station 52 may alter the force applied to blanket 44, and may result in movement of blanket 44 along Y-axis. Note that because the specification of the C2C registration is typically tighter than that of the I2S specification, controller 54 is configured to control actuators 23 and 25 to apply a different tilting angle and different rate of tilting to BTD 99 and BCD 77, respectively, so as to control the movement of blanket 44 along Y-axis, and/or to reduce the distortion in blanket 44.

In some embodiments, controller 54 is configured to apply tilting (using the respective actuators) to one or more selected rollers of system 10. For example, controller 54 may apply tilting to both BTD 99 and BCD 77 concurrently. Alternatively, controller 54 is configured to apply tilting to BCD 77 without applying tilting to BTD 99, or controller 54 may use any other suitable titling scheme applied to one or more selected rollers of system 10. Note that the tilting scheme is determined based on known forces applied to blanket 44, or in response to detecting a respective movement profile in Y-axis.

In some embodiments, controller 54 is configured to hold a look-up table (LUT) (not shown) comprising one or more known distortions caused by one or more operations carried out in system 10, respectively. For example, a blade replacement in blanket treatment station 52, may alter the force applied to blanket 44 in a known manner. In such embodiments, the LUT may be used to feed forward a proactive correction, e.g., controller 54 may control actuator 27 to tilt idler 76 immediately after the blade replacement, so as to proactively reduce or eliminate movement of blanket 44 along Y-axis due to the blade replacement.

In other embodiments, in case BTD 99 is not assembled properly on system 10, BTD 99 may be tilted and not be parallel with at least one of idler 76 and BCD 77. In such embodiments, the LUT may comprise a C2C registration error that is related to the improper assembly of BTD 99, and controller 54 is configured to: (i) display on display 34 a message indicative of the improper assembling, and (ii) hold the operation of system 10 in case the C2C error is larger than a predefined threshold, or control actuator 23 to tilt BTD 99 in accordance with the LUT for reducing the known distortions, e.g., C2C registration.

In some embodiments, controller 54 is configured to control actuator 23 to tilt BTD 99 based on the LUT and signals received from one or more of sensors 11a-11g. As such, controller 54 is configured to compensate for C2C registration errors caused by the distortion of blanket 44, e.g., by tilting least one of BCD 77, BTD 99, and idler 76 of system 10. The compensation may be carried out proactively (based on pre-characterization of system 10 while running the intended printing job) and/or reactively (in response to signals received from at least one of sensors 11a-11g. Moreover, by controlling the tilting level of BCD 77, BTD 99, idler 76, and optionally, other rollers of system 10, controller 54 is configured to control the guiding of blanket 44 and compensate for distortions in blanket 44 and/or the components used for guiding blanket 44.

In some embodiments, controlling the movement of blanket 44 along the Y-axis may be used for reducing the appearance of memory effect in the printing process. The term memory effect refers to a signature of an image printed repeatedly at the same one or more positions on the surface of blanket 44. The memory effect may result in a silhouette of the image that may appear in subsequent prints of another image. The memory effect and embodiments for reducing the appearance thereof are described, for example, in U.S. Provisional Patent Application 63/210,507, and in PCT International Publication WO 2022/263989, whose disclosures are incorporated herein by reference. In some embodiments, the disclosed techniques may be used for altering the position of the image formed on blanket 44, and therefore, for reducing the memory effect as described above.

In other embodiments, instead of or in addition to the LUT, controller 54 is configured to hold a neural network (NN) (not shown), which is trained to identify one or more distortions in blanket 44, such as the distortions shown in FIGS. 2A and 2B above.

In some embodiments, the NN may comprise any suitable type of NN, such as but not limited to a convolutional NN (CNN) or a recurrent NN (RNN) or a combination thereof, which may be trained using supervised or unsupervised raining techniques. For example, the NN may be trained based on known events to identify a known distortion. Based on the trained NN and one or more signals received from one or more of sensors 11a-11g, controller 54 is configured to control one or more of the actuators of system 10 (e.g., one or more of actuators 23, 25 and 27) to apply tilt to the respective roller (e.g., BTD 99, BCD 77 and idler 76) for reducing the one or more identified known or unknown distortions.

Additionally, or alternatively, processor 20 may comprise at least one of the LUT and the NN, and is configured to control one or more of the actuators of system 10 to apply tilt to the respective roller for reducing the one or more identified known or unknown distortions, as described above for controller 54.

The particular configuration of FIG. 3 is simplified for the sake of conceptual clarity and is shown by way of example, in order to illustrate certain problems that are addressed by embodiments of the present invention and to demonstrate the application of these embodiments in enhancing the performance of system 10. Embodiments of the present invention, however, are by no means limited to this specific sort of example system, and the principles described herein may similarly be applied to any other sorts of printing systems using a flexible ITM, or any other sort of ITM. Moreover, the technique of FIGS. 2B and 3 may be used, mutatis mutandis, in any other system that moves a member, and in particular a flexible member, using rollers or other suitable technique to which the disclosed embodiments may be applied.

### Distinguishing Between Blanket Cutting Error and Undesired Movement of the Blanket

FIG. 4 is a schematic side view of a section 47 of blanket 44 and graphs 71 and 72 for illustrating a method for distinguishing between a blanket cutting error and undesired movement of the blanket, in accordance with an embodiment of the present invention. In the context of the present disclosure and in the claims, the term “blanket cutting error” refers to cutting of an edge (e.g., edge 29) of blanket 44 not in parallel with X-axis.

In the example of FIG. 4, when blanket 44 is moved in direction 94 (e.g., parallel to X-axis), a given edge sensor 11 (e.g., sensor 11b or 11d) may detect a movement of edge 29 of section 47 along Y-axis. In some cases, the movement of edge 29 of section 47 along Y-axis may be caused by roughness of edge 29, caused during the production process of blanket 44. For example, insufficient accuracy in the cutting of the fabric of blanket 44 at least in section 47, may cause one or more sections of edge 29 to be not parallel with X-axis. In other cases, the signal received from sensor 11 may indicate a movement of blanket 44 along Y-axis, as shown for example in FIG. 2A above.

Note that in order to correct the distortion caused by the movement along Y-axis, controller 54 must filter out the contribution of the blanket cutting error for quantify the movement speed in Y-axis based on the signal received from sensor 11, as described in FIGS. 2B and 3 above.

Reference is now made to graphs 71 and 72. A graph axis 73 shows the detected position (e.g., shifting) of edge 29 in Y-axis, relative to a reference point, and a graph axis 75 shows the time in which blanket 44 is moved in direction 94. In other words, graphs 71 and 72 show the detected movement of edge 29 over time during a printing process. In the context of the present disclosure, the term “detected movement” refers to the movement of edge 29 as detected based on the signals received from sensor 11. Note that the detected movement may indicate a physical movement of blanket 44 along Y-axis (described for example in FIG. 2A above), or the blanket cutting error described above, or any combination thereof.

Reference is now made to graph 71, during a first revolution of blanket 44, shown with a numeral 81, the detected position of edge 29 of section 47 is outlined using a line 85a. Similarly, during a second revolution of blanket 44, which is subsequent to the first revolution and is shown with a numeral 83, the detected position of edge 29 of section 47 is outlined using a line 85b. The terms first revolution and second revolution refer to an “n revolution” and an “n+1 revolution” of blanket 44, respectively. Note that the second revolution may refer to an “n+10 revolutions” of blanket 44 in system 10, in case the step size of the movement speed of blanket 44 in Y-axis is smaller than a given threshold (e.g., less than about 0.1 mm for each revolution).

In the example of FIG. 4, a dashed line 87 is indicative of the detected movement of a point 91 in axis 73. In graph 71, point 91 has the same value of the detected movement in both revolutions, so that both lines 85a and 85b are touching dashed line 87.

Reference is now made to graph 72, in which lines 85c and 85d illustrate the detected position of edge 29 of section 47 in the first and second revolutions of blanket 44, as described above. Note that lines 85a and 85c are identical, thus, point 91 of line 85c is touching dashed line 87, however, point 91 of line 85d is touching a dashed line 89 located at a distance 93 from dashed line 87. Moreover, point 95 of edge 29 is positioned at a distance 97 from point 91.

In some embodiments, by comparing the detected position of blanket 44 at the same point of edge 29, controller 54 is configured to detect the movement of blanket 44 along Y-axis. In the example of graph 72, distance 97 is indicative of the blanket cutting error in edge 29, and distance 93 is indicative of the movement of blanket along the Y-axis. In such embodiments, based on distance 93 controller 54 is configured to control one or more actuators of system 10 to tilt the respective rollers of system 10 for reducing the distortion caused in blanket 44 due to the movement along Y-axis.

In some embodiments, based on the techniques described in FIG. 4, controller 54 is configured to identify that distance 97 is indicative of the blanket cutting error in edge 29. Therefore, controller 54 does not control any actuator of system 10 to apply tilt a respective roller, because distance 97 is not indicative of any movement of edge 29 along the Y-axis.

In other embodiments, system 10 may comprise at least first and second edge sensors 11 positioned at first and second respective positions along edge 29 of section 47. In such embodiments, controller 54 is configured to calculate the blanket cutting error by comparing between first and second signals received from first and second edge sensors 11, respectively.

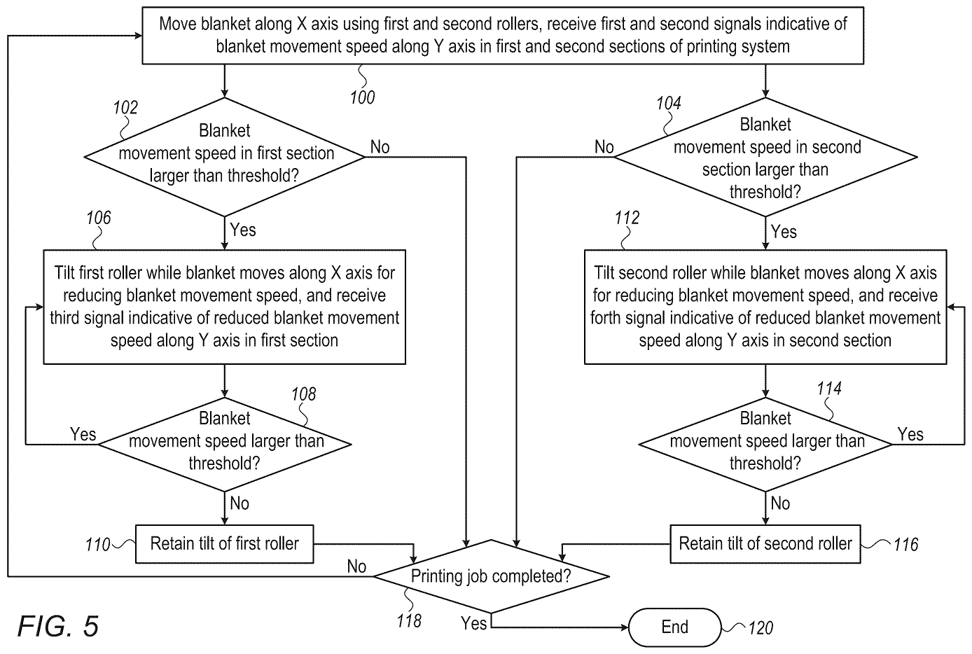

FIG. 5 is a flow chart that schematically illustrates a method for reducing distortion in blanket 44 that undesirably moves along Y-axis during the printing process, in accordance with an embodiment of the present invention.

In some embodiments, the method begins at a blanket movement step 100, with moving blanket 44 along direction 94 (typically parallel to X-axis of system 10) using first and second rollers, such as but not limited to BTD 99 and BCD 77, respectively, as described in FIG. 1 above.

In some embodiments, controller 54 receives from two or more sensors 11 first and second signals indicative of the movement speed of blanket 44 along Y-axis in first and second sections of printing system 10. For example, controller 54 receives: (i) the first signal from sensor 11a positioned in close proximity to BTD 99, and (ii) the second signal from sensor 11c positioned in close proximity to BCD 77, as described in FIGS. 2B and 3 above.

In some embodiments, at a first decision step 102, controller 54 checks, e.g., based on the signal received from sensor 11a, whether edge 30 of blanket 44 is moved along Y-axis at a movement speed larger than a preassigned threshold (e.g., about 1 mm per one revolution of blanket 44).

Similarly, at a second decision step 104, controller 54 checks, e.g., based on the signal received from sensor 11c, whether edge 30 of blanket 44 is moved along Y-axis at a movement speed larger than a preassigned threshold (e.g., about 5 mm per one revolution of blanket 44). In some embodiments, the threshold of step 104 is related to the specified I2S registration of system 10, and the threshold of step 102 is related to the specified C2C registration of system 10, which is typically tighter that that of the I2S specification. In other embodiments, the thresholds of steps 102 and 104 may be similar.

In some embodiments, in case the movement speed in step 102 is smaller than the threshold, controller 54 and processor 20 control system 10 to continue the printing process described in FIG. 1 above.

In other embodiments, in case the movement speed in step 102 is larger than the threshold, the method proceeds to a BTD tilting step 106, in which controller 54 controls actuator 23 to tilt BTD 99 while blanket 44 is moved along X-axis for reducing blanket movement speed in Y-axis, as described in FIG. 3 above.

In some embodiments, controller 54 receives, e.g., from sensor 11a, a signal, referred to herein as a third signal, which is indicative of the reduced blanket movement speed along Y-axis in close proximity to BTD 99 (in response to applying the tilt to BTD 99), as described in detail in FIG. 3 above.

At a third decision step 108, controller 54 checks, e.g., based on the third signal received from sensor 11c, whether edge 30 of blanket 44 is moved along Y-axis at a movement speed larger than the preassigned threshold of step 102 above.

In some embodiments, in case the movement speed of blanket 44 along Y-axis is larger than the threshold, the method loops back to step 106 and controller 54 controls actuator 23 to adjust the tilting of BTD 99 for obtaining a further reduction in the movement speed of blanket 44 along Y-axis in close proximity to BTD 99.

In other embodiments, in case the movement speed of blanket 44 along Y-axis is smaller than the threshold, the method proceeds to a first tilt retaining step 110, in which controller 54 controls actuator 23 to retain the tilt of BTD 99 so that the movement of blanket 44 along Y-axis is stabilized, e.g., has minor amplitude fluctuations around a given value.

In some embodiments, steps 102, 106, 108 and 110 may be applied, mutatis mutandis, to one or more additional rollers of system 10. In the example of FIG. 5, steps 112, 114 and 116 correspond to steps 106, 108 and 110, respectively, and are applied to BCD 77 and actuator 25, as will be described in detail herein. Note that the same technique may be applied to idler 76, sensor 11g and actuator 27, or to any other suitable components of system 10.

In some embodiments, in case the movement speed in step 104 is smaller than the threshold, controller 54 and processor 20 control system 10 to continue the printing process described in FIG. 1 above.

In other embodiments, in case the movement speed in step 104 is larger than the threshold, the method proceeds to a BCD tilting step 112, in which controller 54 controls actuator 25 to tilt BCD 77 while blanket 44 is moved along X-axis for reducing blanket movement speed in Y-axis, as described in FIG. 3 above.

In some embodiments, controller 54 receives, e.g., from sensor 11c, a signal, referred to herein as a fourth signal, which is indicative of the reduced blanket movement speed along Y-axis in close proximity to BCD 77 (in response to applying the tilt to BCD 77), as described in detail in FIG. 3 above.

At a fourth decision step 114, controller 54 checks, e.g., based on the third signal received from sensor 11c, whether edge 30 of blanket 44 is moved along Y-axis at a movement speed larger than the preassigned threshold of step 102 above.

In some embodiments, in case the movement speed of blanket 44 along Y-axis is larger than the threshold of step 104, the method loops back to step 112 and controller 54 controls actuator 25 to adjust the tilting of BCD 77 for obtaining a further reduction in the movement speed of blanket 44 along Y-axis in close proximity to BCD 77.

In other embodiments, in case the movement speed of blanket 44 along Y-axis is smaller than the threshold, the method proceeds to a second tilt retaining step 116, in which controller 54 controls actuator 25 to retain the tilt of BCD 77 so that the movement of blanket 44 along Y-axis is stabilized, e.g., has minor amplitude fluctuations around a given value, which is typically different than the given value of step 110 above.

In some embodiments, in case in steps 102 and 108 the blanket movement speed along Y-axis is smaller than the threshold of step 102, and in case in steps 104 and 114 the blanket movement speed along Y-axis is smaller than the threshold of step 104, controller 54 and processor 20 control system 10 to continue the printing process, as described in steps 102 and 104 above. Moreover, during the printing process the method proceeds to a fifth decision step 118, in which processor 20 or controller 54 check whether the printing job is completed.

In some embodiments, in case the printing job is not completed, the method loops back to step 100, and in case the printing job is completed, the method proceeds to and ending step 120 that concludes the method and carries out various standard operations for terminating the printing process in system 10.

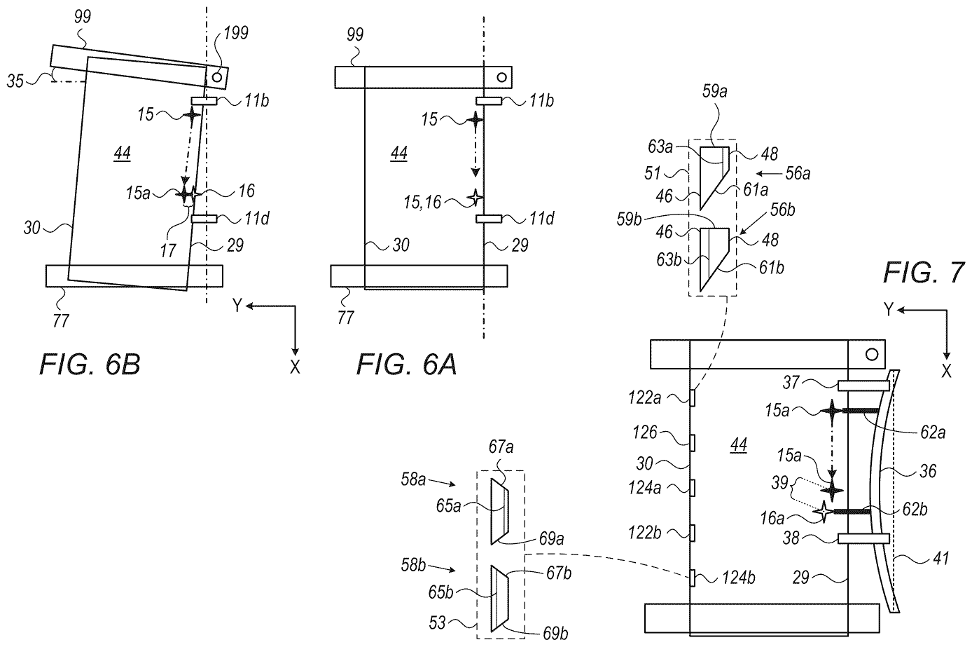

FIG. 6A is a schematic top view showing alignment between the movement of blanket 44 and the printing of patterns at positions 15 and 16 by print bars 62 of system 10, in accordance with an embodiment of the present invention.

In some embodiments, when blanket 44 is aligned with the guiding rollers of system 10, and when obtaining a sufficiently low movement (e.g., approximately no movement) of blanket along the Y-axis, the blue pattern and the magenta pattern are printed in positions 15 and 16, respectively, so that the C2C registration error is smaller than a predefined threshold. In the example of FIG. 6A, BCD 77 and BTD 99 appear to be parallel to one another and to the Y-axis, and edges 29 and 30 of blanket 44 appear to be (i) parallel to one another and to the X-axis, and therefore (ii) orthogonal to BCD 77, BTD 99 and the Y-axis.

In some cases, BCD 77 and BTD 99 may not be positioned parallel to one another and/or one or both edges 29 and 30 of blanket 44 are not positioned orthogonally to one or both of BCD 77 and BTD 99. In some embodiments, based on the signals received from sensors 11 (e.g., sensors 11b and 11d), controller 54 is configured to control actuators 23 and 25 to compensate for the deviation from parallelism and/or orthogonality described above, so as to obtain C2C registration error smaller than a predefined threshold. In other words, even in case of deviation from the aforementioned parallelism and/or orthogonality, controller 54 is configured to obtain the required level of C2C registration, e.g., by controlling the timing of the applying the printing fluids to the surface of blanket 44, or using any other suitable compensation technique.

FIG. 6B is a schematic top view showing detection of undesirable distortion in blanket 44 and/or in the pattern printed by system 10, in accordance with an embodiment of the present invention.

In the example of FIG. 6B, overheating of blanket 44 (and the guiding components thereof) causes thermal expansion of blanket 44, which results in tilting of BTD 99 at an angle about BTD driver 199. The tilting causes C2C registration error 17, as shown and described in FIG. 2A above.

In some embodiments, driver 119 comprises a rotary encoder, which is configured to produce a signal indicative of angle 35 of BTD 99. Based on the signal received from driver 119, controller 54 and/or processor 20 are configured to: (i) estimate the distortion in blanket 44 and C2C registration error 17, and (ii) control a corrective action, such as but not limited to the corrective actions described in FIGS. 2A-5 above.

Moreover, in some cases BTD 99 may be distorted as well (e.g., having an arc shape). In some embodiments, based on the signal received from driver 119, controller 54 and/or processor 20 are configured to estimate the level of distortion in BTD 99, and determine corrective actions, such as replacing BTD 99.

Additionally, or alternatively, processor 20 is configured to receive, e.g., from station 55, signals indicative of C2C registration error 17, so that based on the estimated C2C registration error 17, processor 20 and/or controller 54 are configured to determine the corrective action, such as any of the corrective actions described above.

FIG. 7 is a schematic top view showing detection of a distortion in a sidewall 36 of the chassis of system 10, in accordance with an embodiment of the present invention. The term sidewall refers to any sort of bar or another part of the chassis of system 10, And the other parts of the chassis are removed from FIG. 7 for the sake of conceptual clarity.

In some embodiments, print bars 62a and 62b, which are coupled to sidewall 36, are configured to apply droplets of blue and magenta ink, respectively, to the same position on the surface of blanket 44.

In the present example, sidewall 36 is distorted relative to an axis 41, which is indicative of the longitudinal axis of the original shape of sidewall 36 (before being distorted). Due to the distortion in sidewall 36, at least print bars 62a and 62b have been shifted, and therefore, may direct the droplets of blue and magenta ink, respectively, to positions 15a and 16a, respectively. It is noted that positions 15a and 16a have respective offsets relative to the intended positions 15 and 16 (shown in FIGS. 2A and 2B above) of the droplets (and the pattern formed by the droplets). As such, the offset between positions 15 and 15a, and the offset between positions 16 and 16a, results in a C2C registration error 39.

In some embodiments, in addition to or instead of sensors 11a-11g, system 11 comprises at least edge sensors 37 and 38, which are coupled to sidewall 36 and are sufficiently long in order to produce a first signal indicative of the position of edge 29, and a second signal indicative of the position of sidewall 36.

In some embodiments, based on the first and second signals received from each of edge sensors 37 and 38, processor 20 and/or controller 54 are configured to: (i) estimate the distortion in sidewall 36, and (ii) control at least print bars 62a and 62b to direct the droplets either to positions 15 and 16, respectively, or to any other positions that compensate for C2C registration 39, and thereby, reduce the level of C2C registration below a predefined threshold.

Additionally, or alternatively, processor 20 and/or controller 54 are configured to receive, from sensors 11a-11g, additional signals indicative of the distortion in blanket 44 (and/or in at least BCD 77 and/or BTD 99) as described in FIGS. 2A-5 above. Based on the signals from sensors 11a-11g and from sensors 37 and 38, processor 20 and/or controller 54 are configured to control at least print bars 62a and 62b to direct the droplets either to positions 15 and 16, respectively, or to any other positions that compensate for C2C registration 39, and thereby, to reduce the level of C2C registration to be smaller than the aforementioned predefined threshold.

In some embodiments, blanket 44 comprises marks, which are indicative of respective positions on blanket 44, and more specifically, the positions of these marks are indicative of the start page location on the surface of blanket 44. In the context of the present disclosure and in the claims, the term start page refers to a position on blanket 44 where the printing of an image starts (e.g., a corner of the image intended to be printed).

In some embodiments, the marks are formed on or in one or both edges 29 and 30. In the present example, the marks are formed at predefined (typically equidistance) positions along one or both edges 29 and 30, and serve as a scale of a position encoder along the X-axis of blanket 44, as will be described in more detail below. The marks are typically similar along the edges 29 and 30, but in the present example, marks 122a, 122b, 124a, 124b and 126, which are shown on edge 30 for the sake of presentation, are different from one another as will be described below.

In some embodiments, in case the marks are formed on or in both edges 29 and 30, and based on signals received from sensors (such as sensors 11a-11d and/or sensors 37 and 38) located at and detecting the marks at both edges, processor 20 and/or controller 54 are configured to detect and correct additional distortions in blanket 44, such as but not limited to twisting distortions, which are based on signals received from the sensors at both sides of blanket 44.

In some embodiments, marks 122a, 122b, 124a, 124b and 126 may be formed as stickers, or labels, or tags disposed on one or both edges 29 and 30. In other embodiments, marks 122a, 122b, 124a, 124b and 126 may comprise openings formed in blanket 44 by mechanical piecing, or laser ablation, or chemical etching. In alternative embodiments, marks 122a, 122b, 124a, 124b and 126 may be printed by system 11 or using any other suitable printing system. In case of stickers, labels, tags and printing, marks 122a, 122b, 124a, 124b and 126 may be formed on (i) the outer surface of blanket 44 (that receives the droplets of printing fluids), (ii) the inner surface of blanket 44 (facing the outer surface but not receiving the droplets of printing fluids), or (iii) a suitable combination on the outer and inner surfaces.

Reference is now made to an inset 51 of mark 122a showing right angled trapezoids 56a and 56b having a similar size and shape. Trapezoids 56a and 56b are aligned along the X-axis and have edges 59a and 59b, respectively, which are orthogonal to bases 46 and 48. Trapezoids 56a and 56b further comprise edges 61a and 61b (also referred to herein as diagonal edges that are located at a predefined angle relative to the X-axis), respectively.

In some embodiments, when blanket 44 is moved along the X-axis, the aforementioned sensors, such as sensors 37 and 38 are configured to detect edges 59a and 59b and edges 61a and 61b. In some embodiments, before starting a printing process, blanket 44 is being moved in several revolutions for learning the positions of marks 122a, 122b, 124a, 124b and 126 on blanket 44 (and optionally with respect to predefined locations in blanket 44 and/or system 11). In such embodiments, processor 20 and/or controller 54 are configured to receive from sensors 37 and 38, signals indicative of the position of edges 59a and 59b and edges 61a and 61b. Subsequently, during the printing process and based on the aforementioned learning, processor and/or controller 54 are configured to estimate the speed of blanket 44 along the X-axis, and distortions of blanket 44 along the Y-axis, as will be described herein. It is noted that the same structures are formed along edge 30, for example in mark 122b.

In some embodiments, based on the known distance (along the X-axis) between edges 59a and 59b, processor 20 and/or controller 54 are configured to estimate the speed of blanket 44 along the X-axis. In such embodiments, edges 59a and 59b serve as position encoders at one or both edges 29 and 30 of blanket 44, which can be used to control the position and speed of blanket 44 along the X-axis. Thus, the distance between the marks is determined by the control requirements of the position and speed of blanket 44. As such, the marks may be formed every several millimeters, or every tens of micrometers, or in any other suitable distance between adjacent marks.

In some embodiments, based on the signals received from sensors 37 and 38, processor and/or controller 54 are configured to control the jetting time of every pixel and all the colors in the image, which are printed by the respective print bars 62. Based on the estimated position and speed of blanket 44, processor 20 and/or controller 54 are configured to control suitable positions for each of the printed color images, and suitable scales (typically similar) in all the printed color images, respectively.

In some embodiments, in addition to or instead of the marks formed along the X-axis whose structure and functionality are described in detail above, blanket 44 may comprise suitable marks formed along the Y-axis. Such marks may have the same size and/or shape as that of marks 122, 124 and 126 (described above), but may have any other suitable size and/or shape. For example, (i) a mark similar to mark 122a with a 90-degree rotation of trapezoids 56a and 56b, (ii) a mark similar to mark 124b with a 90-degree rotation of trapezoids 58a and 58b, and (iii) any other suitable mark, e.g., comprising bars (not shown) having any suitable size along the X- and Y-axes, and are typically (a) parallel to the X-axis, and (b) arranged along the Y-axis using any pitch size suitable for detecting additional distortions, such as but not limited to scale distortions along the Y-axis. In such embodiments, based on these marks, processor 20 and/or controller 54 are configured to detect and correct scale distortions along the Y-axis (as well as other sorts of distortions) in at least one of and typically in all the color images of the image printed by system 11. For example, the correction may be carried out by controlling at least one of actuators 23, 25 and 27, as described in detail in FIG. 3 above.

Additionally, or alternatively, the encoder may be implemented using marks 126 having polygon shape, such as a rectangular shape or a square shape, and the sensitivity of the encoder is determined by the distance between the edges of mark 126 that are parallel to the Y-axis (e.g., parallel to edges 59 of marks 122. It is noted that in some cases the intensity of the signal received from sensors 37 and 38 has undesired noise caused, for example, by residues of printing fluids and other sorts of materials. In some embodiments, based on the signals received from sensors 37 and 38, processor 20 and/or controller 54 are configured to estimate the center line (e.g., average position along the X-axis) between the adjacent edges that are parallel to the Y-axis. Averaging the signals reduces errors in readings of the position due to the aforementioned noise.

In some embodiments, based on the estimation (along the X-axis) of (i) a reconstruction 63a of edge 30 passing between edges 59a and 61a, and (ii) a reconstruction 63b of edge 30 passing between edges 59b and 61b, processor 20 and/or controller 54 are configured to estimate a distortion in blanket 44 along the Y-axis. The size of reconstructions 63a and 63b along the X-axis is different because of the (same) slope of edges 61a and 61b, respectively.

It is noted that the distortion in blanket 44 is a physical phenomenon, and therefore, typically occurs between structures that are not in close proximity to one another. In the present example, the distortion along the Y-axis causes movement of edge 30 between (i) reconstruction 63a in mark 122a, and (ii) reconstruction 63b in mark 122b. In other words, based on the detection of edges 59 and 61 in marks 122 (by sensors 37 and 38), processor 20 and/or controller 54 are configured to estimate: (i) the size of reconstructions 63a and 63b along the X-axis, and thereby, (ii) the distortion in blanket 44 along the Y-axis.

Reference is now made to an inset 53 of mark 124b showing isosceles trapezoids 58a and 58b having a similar size and shape. Isosceles trapezoids 58a and 58b are aligned along the X-axis and have (i) edges 67a and 69a, and (ii) edges 67b and 69b, respectively. In the context of the present disclosure and in the claims, edges 67a, 67b, 69a and 69b, are also referred to herein as diagonal edges, which are located at a predefined angle (typically different from the predefined angle of edges 61a and 61b) relative to the X-axis.

In some embodiments, when blanket 44 is moved along the X-axis, a distortion along the Y-axis results in the detection of reconstructions 65a and 65b (of blanket edge 30) in isosceles trapezoids 58a and 58b of marks 124a and 124b, respectively. The size of reconstructions 65a and 65b along the X-axis is determined by: (i) the position of blanket edge along the Y-axis, and (ii) the slope of edges 67 and 69. Based on the known slope of edges 67 and 69 and the estimated size of reconstructions 65a and 65b, processor 20 and/or controller 54 are configured to estimate the distortion in blanket 44 along the Y-axis.

In some embodiments, based on the signals that are received from sensors 37 and 38 and are indicative of the positions of the edges (e.g., edges 67a and 69a of isosceles trapezoid 58a), processor 20 and/or controller 54 are configured to calculate an average of the position of these signals, and to output a center point, e.g., along the X-axis of the line representing reconstruction 65a. As described above, the averaging reduces noise in the intensity of the signals received from sensors 37 and 38, and thereby, improves the accuracy of the position detection and the calculated position and speed of blanket 44 along the X-axis.

Although the embodiments described herein mainly address digital printing using a flexible intermediate transfer member, the methods and systems described herein can also be used in other applications, such as in any sort of printing system and process having any suitable type of an intermediate apparatus (e.g., member) for receiving an image and transferring the image to a target substrate.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
an actuator, which is configured to tilt a roller while an intermediate transfer member (ITM) of a printing system is moved thereon; and
a controller, which is configured to: (i) identify a distortion of the ITM, (ii) hold a lookup table (LUT) comprising one or more known distortions caused by one or more operations carried out in the printing system, respectively, and (iii) control the actuator to tilt the roller in accordance with the LUT to reduce the distortion while the ITM is being moved.

2. The system according to claim 1, wherein the ITM is moved along a continuous path in a first direction, and wherein the controller is configured to reduce the distortion by: (i) identifying a first movement speed of the ITM in a second direction, different from the first direction, and (ii) controlling the actuator to tilt the roller for moving the ITM in a second movement speed, smaller than the first movement speed, while the ITM is being moved in the first direction.

3. The system according to claim 2, wherein the controller is configured to receive a signal indicative of the first movement speed, and to control the actuator responsively to receiving the signal.

4. The system according to claim 3, and comprising (i) a first edge sensor, which is positioned at a first section of the continuous path and is configured to produce a first signal indicative of the first movement speeds at the first section, and (ii) a second edge sensor, which is positioned at a second section of the continuous path, different from the first section, and is configured to produce a second signal indicative of the first movement speed at the second section.

5. The system according to claim 4, wherein, in response to receiving the first and second signals, the controller is configured to identify a first distortion in the first section and a second distortion in the second section.

6. The system according to claim 5, wherein the actuator comprises a first actuator configured to tilt a first roller and a second actuator configured to tilt a second roller, wherein, in response to identifying the first and second distortions, the controller is configured to control at least one of the first and second actuators to tilt the first and second rollers, respectively.

7. The system according to claim 6, wherein the controller is configured to control: (i) the first actuator to tilt the first roller in a first tilting angle, and (ii) the second actuator to tilt the second roller in a second tilting angle, different from the first tilting angle.

8. The system according to claim 6, wherein the controller is configured to control the first and second actuators to apply the first and second tilts concurrently.

9. The system according to claim 1, wherein the ITM is configured for receiving ink droplets to form an image thereon, and for transferring the image to a target substrate.

10. (canceled)

11. The system according to claim 1, wherein the one or more known distortions comprises a first known distortion in a first section on the ITM and a second known distortion in a second section of the ITM, and comprising a first actuator configured to tilt a first roller of the printing system and a second actuator configured to tilt a second roller of the printing system, and wherein, in response to identifying the first and second known distortion, the controller is configured to control at least one of the first and second actuators to tilt the first and second rollers, respectively

12-34. (canceled)

35. A method, comprising:
identifying a distortion of an intermediate transfer member (ITM) that is moved on a roller of a printing system;
holding a lookup table (LUT) comprising one or more known distortions caused by one or more operations carried out in the printing system, respectively; and
controlling an actuator to tilt the roller to reduce the distortion while the ITM is being moved.

36. The method according to claim 35, wherein the ITM is moved along a continuous path in a first direction, and wherein reducing the distortion comprises:
(i) identifying a first movement speed of the ITM in a second direction, different from the first direction, and
(ii) tilting the roller for moving the ITM in a second movement speed, smaller than the first movement speed, while the ITM is being moved in the first direction.

37. The method according to claim 36, and comprising receiving a signal indicative of the first movement speed, and controlling the actuator responsively to the received signal.

38. The method according to claim 37, and comprising (i) a first edge sensor, which is positioned at a first section of the continuous path for producing a first signal indicative of the first movement speeds at the first section, and (ii) a second edge sensor, which is positioned at a second section of the continuous path, different from the first section, for producing a second signal indicative of the first movement speed at the second section.

39. The method according to claim 38, and comprising identifying a first distortion in the first section and a second distortion in the second section in response to receiving the first and second signals.

40. The method according to claim 39, wherein the actuator comprises a first actuator for tilting a first roller and a second actuator for tilting a second roller, and comprising controlling at least one of the first and second actuators to tilt the first and second rollers, respectively, in response to identifying the first and second distortions.

41. The method according to claim 40, wherein controlling the first and second actuators comprises controlling: (i) the first actuator to tilt the first roller in a first tilting angle, and (ii) the second actuator to tilt the second roller in a second tilting angle, different from the first tilting angle.

42. The method according to claim 40, wherein controlling the first and second actuators comprises controlling the first and second actuators to apply the first and second tilts concurrently.

43. The method according to claim 35, and comprising receiving ink droplets applied to the ITM to form an ink image thereon, and transferring the ink image from the ITM to a target substrate.

44. (canceled)

45. The method according to claim 35, wherein the one or more known distortions comprises a first known distortion in a first section on the ITM and a second known distortion in a second section of the ITM, and comprising first and second actuator for tilting a first roller of the printing system, and a second roller of the printing system, respectively, and wherein, in response to identifying the first and second known distortions, controlling at least one of the first and second actuators to tilt the first and second rollers, respectively.

46-68. (canceled)
